(19) United States
(12) Patent Application Publication
(10) Pub. No.: US 2012/0143604 A1
(43) Pub. Date: Jun. 7, 2012

(54) Method for Restoring Spectral Components in Denoised Speech Signals

(76) Inventor: Rita Singh, Pittsburgh, PA (US)

(21) Appl. No.: 12/962,036

(22) Filed: Dec. 7, 2010

(51) Int. Cl. G10L 21/02

(52) U.S. Cl. 704/226; 704/E21.002

(57) ABSTRACT

Spectral components attenuated in a test denoised speech signal as a result of denoising a test speech signal are restored by representing a training undistorted speech signal as a composition of training undistorted bases, and representing a training denoised speech signal as a composition of training distorted bases. The test denoised signal decomposed as a composition of the training distorted bases. The undistorted test speech signal is then estimated as the composition of the training undistorted bases that is identical to the composition of training distorted bases.

### FIELD OF THE INVENTION

This invention relates generally to denoised speech signals, and more particularly to restoring spectral components attenuated in the speech signals as a result of the denoising.

### BACKGROUND OF THE INVENTION

A speech signal is often acquired in a noisy environment. In addition to reducing the perceptual quality and intelligibility of the speech, noise negatively affects the performance of downstream processing such as coding for transmission and recognition, which are typically optimized for efficient performance on an undistorted “clean” speech signal. For this reason, it becomes necessary to denoise the signal before further processing. A large number of denoising methods are known. Typically, the conventional methods first estimate the noise, and then reduce the noise either by subtraction or filtering.

The problem is that the noise estimate is usually inexact, especially when the noise is time-varying. As a result, some residual noise remains after denoising, and information carrying spectral components are attenuated. For example, if speech is acquired in a vehicle, then the denoised, high-frequency components of fricated sounds such as /S/, and very-low frequency components of nasals and liquids, such as /M/, /N/ and /L/ are attenuated. This happens because automotive noise is dominated by high and low frequencies, and reducing the noise attenuates these spectral components in the speech signal.

Although noise reduction results in a signal with improved perceptual quality, the intelligibility of the speech often does not improve, i.e., while the denoised signal sounds undistorted, the ability to make out what was spoken is decreased. In some cases, particularly when the denoising is aggressive or when the noise is time-varying, the denoised signal is less intelligible than the noisy signal.

This problem is the result of imperfect processing. Nevertheless, it is a very real problem for a spoken-interface device that incorporates third-party denoising hardware or software. The denoising techniques are often “black boxes” that are integrated into the device, and only the denoised signal is available. In this case, it becomes important to somehow restore the spectral components of the speech information that the denoising attenuated.

### SUMMARY OF THE INVENTION

Noise degrades speech signals, affecting the perceptual quality, intelligibility, as well as downstream processing, e.g., coding for transmission or speech recognition. Hence, noisy speech is denoised. Typically, denoising methods subtract or filter an estimate of the noise, which is often inexact. As a result, denoising can attenuate spectral components of the speech, and reducing intelligibility.

A training undistorted speech signal is represented as a composition of training undistorted bases. A training denoised speech is represented a composition of training distorted bases. By decomposing the test denoised speech signal as a composition of the training distorted bases. Then, a corresponding test undistorted speech signal can be estimated as an identical composition of the training undistorted bases.

### BRIEF DESCRIPTION OF THE DRAWINGS

FIG. 1 is a model of a denoising process 100 according to embodiments of the invention;

FIG. 2 is a flow diagram of a method for restoring spectral components in a test denoised speech signal according to embodiments of the invention;

FIG. 3 is a flow diagram detailing conversion of an estimated short-time Fourier transform to a time-domain signal; and

FIG. 4 is a flow diagram detailing conversion of an estimated short-time Fourier transform to a signal when bandwidth expansion is performed.

### DETAILED DESCRIPTION OF THE PREFERRED EMBODIMENT

The embodiments of the invention provide a method for restoring spectral components attenuated in a test denoised speech signal as a result of denoising a test speech signal to enhance the intelligibility of the speech in the denoised signal.

The method is constrained by practical aspects of the denoising. First, the denoising is usually a “backbox.” The manner in which the noise is estimated, and the actual noise reduction procedure are unknown. Second, it is usually impossible or impractical to record the noise itself separately, and no external estimate of the noise is available to understand how the denoising has affected any spectral components of the speech. Third, the processing must restore the attenuated spectral components of the speech without reintroducing the noise into the signal.

The method uses a compositional characterization of the speech signal that assumes that the signal can be represented as a constructive composition of additive bases.

In one embodiment, this characterization is obtained by non-negative matrix factorization (NMF), although other techniques can also be used. NMF factors a matrix into matrices with non-negative elements. NMF has been used for separating mixed speech signals and denoising speech. Compositional models have also been used to extend the bandwidth of bandlimited signals. However, as best as known, NMF has not been used for the specific problem of restoring attenuated spectral components in a denoised speech signal.

The manner in which the composition of the additive bases is affected by the denoising is relatively constant, and can be obtained from training data comprising stereo pairs of training undistorted signals and training distorted speech signals. By determining how the denoised signal is represented in terms of the composition of the additive bases, the attenuated spectral structures can be estimated from the undistorted versions of the bases, and subsequently restored to provide undistorted speech.

Denoising Model

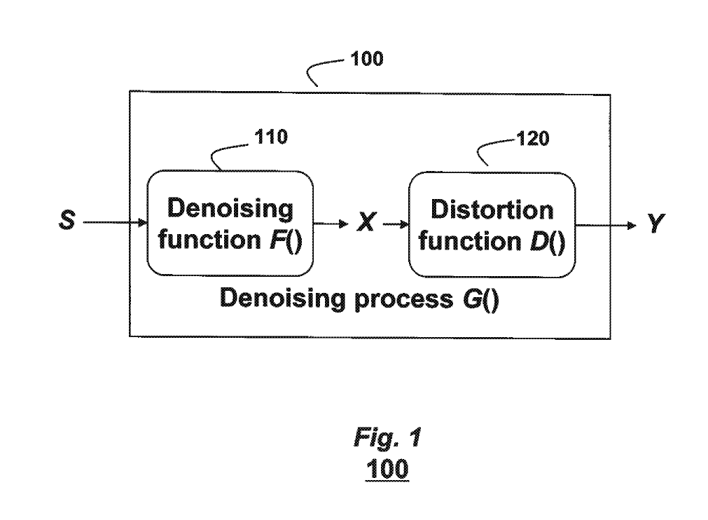

As shown in FIG. 1, the embodiments of the invention model a lossy denoising process G( ) 100, which inappropriately attenuates spectral components of noisy speech S, as a combination of a lossless denoising mechanism F( ) 110 that attenuates the noise in the signal without attenuating any speech spectral components, and a distortion function D( ) 120 that modifies the losslessly denoised signal X to produce a lossy signal Y.

That is, the noisy speech signal S is processed by an ideal “lossless” denoising function F(S) 110 to produce a hypothetical lossless denoised signal X. Then, the denoised signal X is passed through a distortion function D(X) 120 that attenuates the spectral components to produce a lossy signal Y.

The goal is to estimate the denoised signal X, given only the lossy signal Y. The embodiments of the invention express the lossless signal X as a composition of weighted additive bases wᵢBᵢ

$$X = {\sum }_{i = 1}^{K} {w}_{i} {B}_{i} . \qquad ( 1 )$$

The bases Bᵢ are assumed to represent uncorrelated building blocks that constitute the individual spectral structures that compose the denoised speech signal X. The distortion function D( ) distorts the bases to modify the spectral structure the bases represent. Thus, any basis Bᵢ is transformed by the distortion function to Bᵢ^{distorted}=D(Bᵢ).

It is assumed that the distortion transforms any basis independently of other bases, i.e.,

D(Bᵢ|Bⱼ:j≠i)=D(Bᵢ),

where D(Bᵢ|Bⱼ:j≠i) represents the distortion of the bases Bᵢ given that the other bases Bⱼ, j≠i are also concurrently present. This assumption is invalid unless the bases represent non-overlapping, complete spectral structures. It is also assumed that the manner in which the bases are combined to compose the signal is not modified by the distortion. These assumptions are made to simplify the method. The implication of the above assumptions is that

$$Y = D ( X ) ⇒ X = {\sum }_{i}^{ } {w}_{i} {B}_{i} ⇔ Y = {\sum }_{i}^{ } {w}_{i} {B}_{i}^{distorted} \qquad ( 2 )$$

Eqn. 2 leads to the conclusion that if all bases Bᵢ and their distorted versions Bᵢ^{distorted} are known, and if the manner in which the distorted bases compose Y can be determined, i.e., if the weights wᵢ can be estimated, then the denoised signal X can be estimated.

Restoration Method Overview

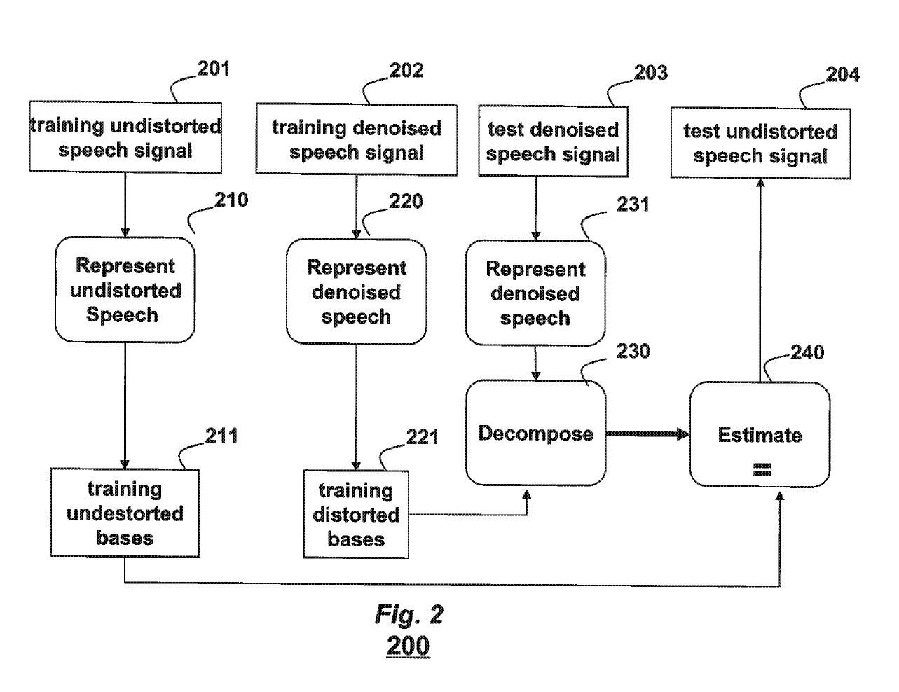

FIG. 2 shows the steps of a method 200 for restoring spectral components in a test denoised speech signal 203. A training undistorted speech signal 201 is represented 210 as a composition of training undistorted bases 211. A training denoised speech 202 is represented 220 a composition of training distorted bases 221. By decomposing 230 the test denoised speech signal 203 according to the composition of the training distorted bases 221, a corresponding test undistorted speech signal 204 can be estimated 240 as the composition of the training undistorted bases 211 that is identical to the composition of the training distorted bases 221. The steps of the above method can be performed in a processor connected to a memory and input/output interfaces as known in the art.

Representing the Signal

The model described and shown in FIG. 1 is primarily a spectral model. The model characterizes a composition of uncorrelated signals, which leads to a spectral characterization of all signals, because the power spectra of uncorrelated signals are additive. Therefore, all speech signals are represented as magnitude spectrograms that are obtained by determining short-time Fourier transforms (STFT) of the signals and computing the magnitude of its components. In theory, it is the power spectra that are additive. However, empirically, additivity holds better for magnitude spectra.

An optimal analysis frame for the STFT is 40-64 ms. Hence, the speech signals are segmented by sliding a window of 64 ms over the signals to produce the frames. A Fourier spectrum is computed over each frame to obtain a complex spectral vector. Its magnitude is taken to obtain a magnitude spectral vector. The set of complex spectral vectors for all frames compose the complex spectrogram for the signal. The magnitude spectral vectors for all frames compose the magnitude spectrogram. The spectra for individual frames are represented as vectors, e.g., X(t), Y(t).

Let S, X, and Y represent magnitude spectrograms of the noisy speech, losslessly denoised speech and lossy denoised speech, respectively. The bases Bᵢ, as well as their distorted versions Bᵢ^{distorted} represent magnitude spectral vectors. The magnitude spectrum of the t^{th} analysis frame of the signal X, which is represented as X(t), is assumed to be composed from the lossless bases Bᵢ as

X(t)=Σᵢwᵢ(t)Bᵢ,

and the magnitude spectrum of the corresponding frame of the lossy signal Y is

Y(t)=Σᵢwᵢ(t)Bᵢ^{distorted}.

Also, the weights wᵢ are now all non-negative, because the signs of the weights in the model of Eqn. are incorporated into the phase of the spectra for the bases, and do not appear in the relationship between magnitude spectra of the signals and the bases.

The spectral restoration method estimates the lossless magnitude spectrogram X from that of the lossy signal Y. The estimated magnitude spectrogram is inverted to a time-domain signal. To do so, the phase from the complex spectrogram of the lossy signal is used.

Restoration Method Details

For restoration, in a training phase, the lossless bases Bᵢ 211 for the signal X and the corresponding lossy bases Bᵢ^{distorted} 221 for the signal Y are obtained from training data, i.e., the training undistorted speech signal 201 and the training denoised speech signal 202. After training, during operation of the method, these bases are employed to estimate the denoised signal X.

Obtaining the Bases

Because the distortion function D( ) 120 is unknown, the bases Bᵢ and Bᵢ^{distorted} are jointly obtained from analysis of joint recordings of the signal X and the corresponding signal Y. Therefore, the joint recordings of the training signals X and Y are needed in the training phase. However, the signal X is not directly available, and the following approximation is used instead.

An undistorted (clean) training speech signals C is artificially corrupt with digitally added noise to obtain the noisy signal S. Then, the signal S is processed with the denoising process 110 to obtain the corresponding signal Y. The “losslessly denoised” signal X is a hypothetical entity that also is unknown. Instead, the original undistorted clean signal C is used as a proxy for X for the signal. The denoising process and the distortion function introduce a delay into the signal so that the signals for Y and C are shifted in time with respect to one another.

Because the model of Eqn. 2 assumes a one-to-one correspondence between each frame of X and the corresponding frame of Y, the recorded samples of the signals C and Y are time aligned to eliminate any relative time shifts introduced by the denoising. The time shift is estimates by cross-correlating each frame of the signal C and the corresponding frame of the signal Y.

The bases Bᵢ are assumed to be the composing bases for the signal X. The bases can be obtained by analysis of magnitude spectra of signals using NMF. However, as an additional constraint, the distorted bases Bᵢ^{distorted} must be reliably known to actually be distortions of their undistorted counterpart bases Bᵢ.

Therefore, an example based model is used, where such a correspondence is assured. A large number of magnitude spectral vectors are randomly selected from the signal C as the bases Bᵢ for the signal X. The corresponding vectors are selected from the training instances of the signal Y as Bᵢ^{distorted}. This ensures that Bᵢ^{distorted} is indeed a near-exact distorted version of Bᵢ. Because the bases represent spectral structures in the speech, and the potential number of spectral structures in speech is virtually unlimited, a large number of training bases are selected, e.g., 5000 or more. The model of Eqn. 1 thus becomes overcomplete, combining many more elements than the dimensionality of the signal itself.

Estimating Weights

The method for restoring spectral components in the test denoise signal Y 203 determines how each spectral vector Y(t) of Y is composed by the distorted bases. As stated above, Y(t)=Σᵢwᵢ(t)Bᵢ^{distorted}.

If the set of all training distorted bases 221 is represented as a matrix B̅=[{Bᵢ^{distorted}}], and the set of weights {wᵢ(t)} as a vector: W(t)=[w₁(t)w₂(t) . . . ]^{T}, then

Y(t)= B̅W(t) (3)

The vector W(t) is constrained to be non-negative during the estimation. A variety of update rules are known for learning the weights. For speech and audio signals, it most effective to employ the update rule that minimizes the generalized Kullback-Leibler distance between Y(t) and B̅W(t):

$$W ( t ) ← W ( t ) ⊗ \frac{{\overline{B}}^{T} \frac{Y ( t )}{\overline{B} W ( t )}}{{\overline{B}}^{T} 1} , \qquad ( 4 )$$

where \hat{x} represents component-wise multiplication, and all divisions are also component-wise. Because the representation is overcomplete, i.e., there are more bases than there are dimensions in Y(t)), the equation is underdetermined and multiple solutions for W(t) exist that characterize Y(t) equally well.

Estimating the Speech with Restored Spectral Components

After the weights W(t)=[w₁(t)w₂(t) . . . ]^{T} are determined for any Y(t), by Eqn. 2 the corresponding lossless spectrum X(t) can be estimated as X(t)=Σᵢwᵢ(t)Bᵢ. Because the estimation procedure is iterative, the exact equality in Eqn. 3 is never achieved. Instead, the matrix B̅W(t) is only an approximation to Y(t). To account for the entire energy in the signal Y, the following Wiener filter formulation is used to estimate the spectral vectors of X

$$X ( t ) = ( Y ( t ) + ε ) ⊗ \frac{{\sum }_{i}^{ } {w}_{i} ( t ) {B}_{i}}{{\sum }_{i}^{ } {w}_{i} ( t ) {B}_{i}^{distorted} + ε} . \qquad ( 5 )$$

All divisions and multiplications above are component-wise, and ε>0 to ensure that attenuated spectral components can still be restored when Y(t)=0.

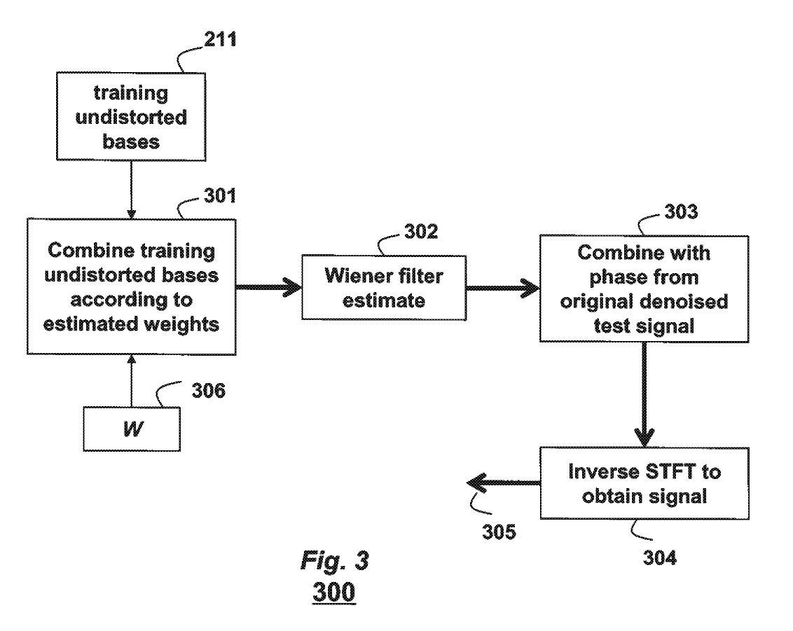

FIG. 3 shows the overall process 300 for restoring the undistorted test signal, after weights are estimated. The initial estimate, shown by the numerator of Eqn. (5), is determined 301 by combining the training undistorted bases 211 according to the estimated weights 306. The result is then used in the Wiener filter estimate 302. The resulting STFT is combined 303 with the phase from the STFT of the denoised test signal, and finally converted to a time-domain signal 305 by performing the inverse SIFT 304.

Expanding the Bandwidth

Often, the recorded and denoised speech signal has a reduced bandwidth, e.g., if the speech is acquired by telephony, then the speech may only include low frequencies up to 4 k Hz, and high frequencies above 4 k Hz are lost. In these cases, the method can be extended to restore high-frequency spectral components into the signal. This is also expected to improve the intelligibility of the signal. To expand the bandwidth, a bandwidth reconstruction procedure can be used, see U.S. Pat. No. 7,698,143, “Constructing broad-band acoustic signals from lower-band acoustic signals,” issued to Ramakrishnan et al. on Apr. 13, 2010, incorporated herein by reference. That procedure is only concerned with constructing broad-band acoustic signals from lower-band acoustic signals, and not denoised speech signals, as here.

In this case, the training data also includes wideband signals for the training undistorted signal C. The training recordings for C and Y are time aligned, and STFT analysis is performed using identical analysis frames. This ensures that in any joint recording there is a one-to-one correspondence between the spectral vectors for the signals C and Y. Consequently, while the bases Bᵢ^{distorted} 221, drawn from training instances of Y, represent reduced-bandwidth signals, the corresponding bases Bᵢ 211 represent wideband signals and include high-frequency components. After the signals are denoised, low-frequency components are restored using Eqn. 5, and the high-frequency components are obtained as

X(t,f)=Σᵢwᵢ(t)Bᵢ(f),fε{high frequency},

where f is an index to specific frequency components of X(t) and Bᵢ.

The above estimate only determines spectral magnitudes. To invert the magnitude spectrum to a time-domain, a signal phase is also required. The phase for low-frequency components is taken directly from the reduced-bandwidth lossy denoised signal. For higher frequencies, it is sufficient to replicate the phase terms from the lower frequencies.

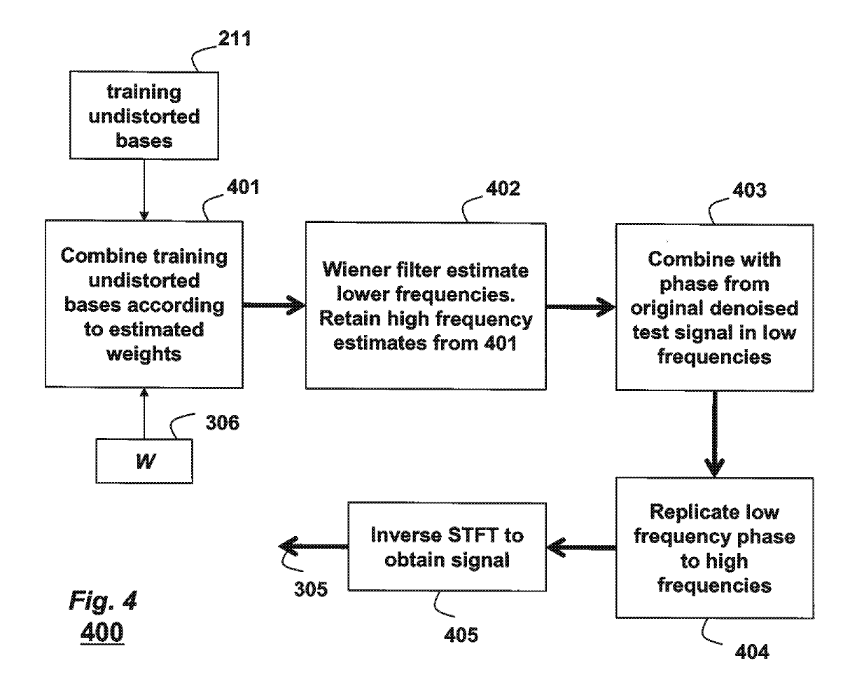

FIG. 4 shows the overall process for restoring the undistorted test signal with bandwidth expansion, after weights are estimated. The initial estimate for both the low and high-frequency components, shown by the numerator of Eqn. (5), is determined 401. Low frequency components are updated using the Wiener filter estimate 402, while retaining high frequency estimates from step 401. The resulting STFT is combined 403 with the phase from the SIFT of the denoised test signal in low frequencies. Phases of low frequencies are replicated 404 to high frequencies, and finally converted to a time-domain signal by performing the inverse STFT 405.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for restoring spectral components attenuated in a test denoised speech signal as a result of denoising a test speech signal, comprising:
representing a training undistorted speech signal as a composition of training undistorted bases;
representing a training denoised speech signal as a composition of training distorted bases;
decomposing the test denoised signal as a composition of the training distorted bases;
estimating the undistorted test speech signal as the composition of the training undistorted bases that is identical to the composition of training distorted bases.

2. The method of claim 1, wherein a process for producing the test denoised speech signal is unknown, and further comprising:
modeling the process by an ideal lossless denoising function to produce a denoised signal that is hypothetically lossless, and passing the denoised signal through a distortion function that attenuates the spectral components.

4. The method of claim 1, wherein all the bases are additive, and each bases is associated with a weight.

5. The method of claim 2, wherein the distortion function transforms any basis independently of any other bases.

6. The method of claim 1, further comprising:
representing all speech signals as magnitude spectrograms that are obtained by determining magnitudes of short-time Fourier transforms (STFTs) of the speech signals.

7. The method of claim 1, wherein the training undistorted bases and the training distorted bases are determined by a joint analysis of magnitude spectrograms of training data, wherein the training data comprise pairs of recordings, where each pair includes a clean speech signal, and an artificially corrupted version of the clean speech signal that has been corrupted by adding of noise and then denoising the corrupted version.

8. The method of claim 7, wherein samples of the clean speech signal, and the artificially corrupted and denoised version of the clean speech signal are time aligned.

9. The method of claim 8, wherein the undistorted training bases and the distorted training bases are determined by joint analysis of the pairs of recordings.

10. The method of claim 1, wherein the training undistorted bases and the training distorted bases are determined using an example-based model, and wherein the training undistorted bases and the training distorted bases are randomly selected from among magnitude spectral vectors for the training undistorted bases and the training distorted bases.

11. The method of claim 4, wherein the weights are non-negative.

12. The method of claim 4 where the weights are determined by non-negative matrix factorization (NMF).

13. The method of claim 1, further comprising:
expanding a bandwidth of the test undistorted speech signal.

14. The method of claim 7 or 13, wherein the training undistorted bases are obtained from a full-bandwidth clean speech signal and the training distorted bases are obtained from a reduced-bandwidth, artificially noise-corrupted, and denoised speech signal.

15. The method of claims 1, wherein the estimated test undistorted speech signal is obtained by combining the training undistorted bases using weights determined by non-negative matrix factorization (NMF).

16. The method of claim 1, wherein final magnitude spectra composing estimated magnitude short-time Fourier transforms (STFTs) of the test undistorted speech signal is obtained by applying using a Wiener filter formulation to an estimated undistorted spectra.

17. The method of claim 16, where the estimated test undistorted speech signal is obtained by and combining the inverted estimated magnitude STFTs with a phase obtained from the STFT of the test denoised speech signal and inverting the resulting complex STFT.

18. The methods of claim 16, wherein frequency components greater than 4 k HZ of the STFT of the estimated test undistorted speech signal are obtained directly from the combination of the training undistorted bases.

19. The method of claim 17 or 18, wherein a phase for the frequency components greater than 4 kHz of the STFT is obtained by replicating phase of low-frequency components less than 4 k HZ of the STFT of the estimated test undistorted speech signal.
